(19) United States
(12) Patent Application Publication
(10) Pub. No.: US 2008/0218866 A1
(43) Pub. Date: Sep. 11, 2008

(54) DISPLAY ELEMENT

(76) Inventors: Yasushi KAWATA, Ageo-shi (JP); Masaki OBI, Ageo-shi (JP); Akio MURAYAMA, Fukaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/021,156

(22) Filed: Jan. 28, 2008

(30) Foreign Application Priority Data
Mar. 6, 2007 (JP) 2007-055276

(51) Int. Cl. G02B 27/00

(52) U.S. Cl. 359/609

(57) ABSTRACT

On the back surface of a window member and a display surface of a liquid crystal display panel, the same antireflective structures having a plurality of convexities with predetermined dimensions not more than the wavelength of visible light are formed, respectively. While the liquid crystal display panel is protected by the window member, reflection of external light on the back surface of the window member and the display surface of the liquid crystal display panel and reflection of outgoing light from the liquid crystal display panel can be reduced by the convexities of the antireflective structures, so that visibility can be secured.

### INCORPORATION BY REFERENCE

The present application claims priority under 35 U.S.C. §119 to Japanese Patent Application No. 2007-055276 filed on Mar. 6, 2007. The content of the application is incorporated herein by its entirety.

### FIELD OF THE INVENTION

The present invention relates to a display element including a window member provided so as to oppose a display surface of a display element main body.

### BACKGROUND OF THE INVENTION

At present, various electronic equipment including mobile phones using display elements such as liquid crystal displays (LCDs) as display panels that are display element main bodies are structured so that, to protect the display element from water, dust, or external forces, the display panel is not directly exposed but a window member such as a transparent plastic plate is provided on the outside and a gap is formed between the window member and the display panel.

For example, in the case of a mobile phone, a display element of a casing is constituted by a window member formed of a transparent base material such as a resin molded product, and below, that is, on the inner side of the display element, a display panel mounted on a substrate is disposed so as to be protected.

However, in this constitution, by additionally interposing the window member for protecting the display panel between the display panel and a viewer, external light is reflected on the window member and the top surface of the display panel disposed below the window member and the display becomes different to view, or display light from the display panel is reflected by the window member and the light use efficiency lowers, so that the visibility is lowered although the objective of protection is achieved.

Therefore, for example, it is considered that a single layer antireflective coating or a multilayer antireflective coating including a low refractive index layer and a high refractive index layer is formed on the window member by using, for example, vapor deposition, sputtering, or coating, or an antireflective film is adhered thereon.

However, to form an antireflective coating by vapor deposition, sputtering, or the like, a thin film whose refractive index is controlled by one or a large number of times of batch processing must be formed, and this brings about problems in stability and conforming ratio of the product, and the productivity is insufficient. To form an antireflective coating by coating, the antireflective coating must be coated on each product, and the productivity in this case is also insufficient.

Therefore, conventionally, for example, Japanese Laid-Open Patent Publication No. 2003-4916 proposed a constitution of a display element including a transparent window member that has a fine concavoconvex structure provided on only the back surface of the window member. In this constitution, a refractive index change between the window member and the air on the back surface of the window member can be set to be not discontinuous and rapid but continuous and gradual.

Light reflection on a material interface is caused by a rapid refractive index change, so that by setting the refractive index change on the window member back surface to be continuous and gradual, the light reflection on the window member back surface can be reduced, and as wavelength components that influence the visibility of the display, external light from the outside of the window member, more specifically, in the reflection on the window front and back surfaces toward the viewer side of light with a wavelength in the visible light range of the external light, reflection on the back surface of the window member can be removed.

However, in the above-described constitution, between the window member back surface and the top surface of the display panel opposing the window member back surface, a low refractive index layer such as air exists, so that the most of the light that is not reflected but transmitted through the window member back surface is reflected on the top surface of the display panel disposed below the window member, and this further lowers the visibility.

The present invention has been made in consideration of these problems, and an object thereof is to provide a display element which secures visibility while protecting the display element main body.

### SUMMARY OF THE INVENTION

A display element of the present invention is provided with a display element main body having a display surface on which images are displayed and a window member which is translucent and is provided so as to oppose the display surface of the display element main body, wherein on the display surface and a principal surface of the window member opposing the display surface, the same antireflective structure including a plurality of convexities with predetermined dimensions not more than the wavelength of visible light is formed, respectively.

By forming the same antireflective structure including a plurality of convexities with predetermined dimensions not more than the wavelength of visible light on the display surface of the display element main body and the principal surface, opposing the display surface, of the window member provided so as to oppose the display surface, respectively, reflection of external light and reflection of outgoing light from the display element main body are reduced by the convexities of the respective antireflective structures while the display element main body is protected by the window member, whereby visibility can be secured.

### BRIEF DESCRIPTION OF THE DRAWINGS

FIG. 1 is an explanatory sectional view showing a display element of an embodiment of the present invention;

FIG. 2 is a circuit diagram showing a part of the display element;

FIG. 3 is an explanatory sectional view showing a base material forming step of a method of producing the display element;

FIG. 4 is an explanatory sectional view showing a mold forming step of the method of producing the display element; and

FIG. 5 is an explanatory sectional view showing a film adhering step of the method of producing the display element.

### DETAILED DESCRIPTION OF THE PREFERRED EMBODIMENT

Hereinafter, a constitution of a display element of an embodiment of the present invention will be described with reference to the drawings.

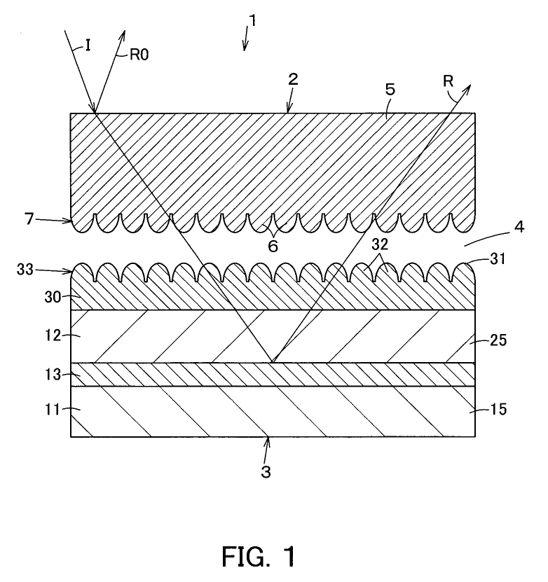

In FIG. 1, the reference numeral 1 denotes a liquid crystal display element as the display element, and this liquid crystal display element 1 is constituted so that, below a window member 2 for protection, a liquid crystal display panel 3 that is a liquid crystal display element main body as a display element main body is disposed, and between these window member 2 and the liquid crystal display panel 3, a layer of the air 4 as a medium with a refractive index of 1 is formed.

The window member 2 is positioned on the viewer side of the liquid crystal display element 1, and includes a transparent base material 5 formed into a plate shape from a predetermined transparent material, and on the back surface as a principal surface of the transparent base material 5 opposing the liquid crystal display panel 3, an antireflective structure 7 that is a fine concavoconvex structure including a plurality of convexities 6 is formed.

Each convexity 6 is formed into predetermined dimensions whose height and width are for example, 100 to 400 nanometers, not more than the wavelength of visible light, different from the conventional anti-glare treatment which scatters (diffuses and reflects) light by using a matted (frosted) surface formed by concaves and convexes not less than the wavelength of visible light. These convexities 6 are arranged irregularly in the entire region covering at least the liquid crystal display panel 3 on the back surface of the transparent base material 5, and the antireflective structure 7 forms a so-called moth-eye structure.

The convexities 6are arranged so as not to have periodicity of L/K (K: integer not less than 1) when the wavelength of visible light is defined as L. In other words, the convexities 6 are arranged in a single or a plurality of aggregations so as not to have periodicity on the wavelength level of visible light. Specifically, the antireflective structure 7 is constituted so as not to have wavelength dependency with respect to the visible light and view angle dependency.

As a result, the antireflective structure 7 can prevent reflection of light (external light) due to a rapid refractive index change caused by discontinuity of a material interface by changing the rapid and discontinuous refractive index change between the transparent base material 5 and the air 4 into a continuous and gradual refractive index change by the convexities 6.

On the other hand, the liquid crystal display panel 3 is a liquid crystal display (LCD), and in the present embodiment, it is described as a reflection type which displays images by reflecting incoming light, however, for example, it may be a transmission type which displays images by transmitting light from a backlight, or may be a semi-transmission type formed by combining the transmission type and the reflection type.

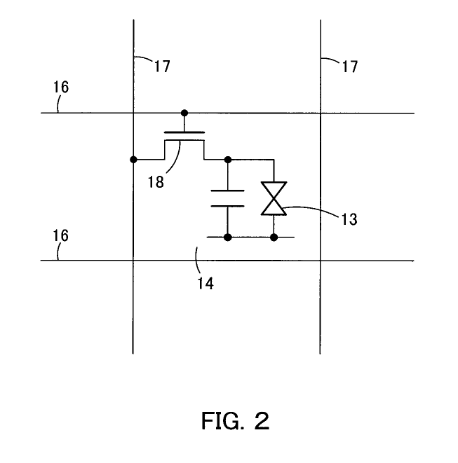

This liquid crystal display panel 3 includes an array substrate 11 as a substrate, a counter substrate 12 opposing this array substrate 11, and a liquid crystal layer 13 as a light modulating layer interposed between the substrates 11 and 12. This liquid crystal display panel 3 is an active matrix type including pixels 14 shown in FIG. 2 formed in a matrix.

In the array substrate 11, on the principal surface on the upper side in the drawing of a transparent substrate 15 with insulation such as a glass substrate, pluralities of scanning lines 16 and signal lines 17 shown in FIG. 2 are arranged in a grid pattern orthogonal to each other, and at the respective intersections of the scanning lines 16 and the signal lines 17, thin film transistors (TFTs) 18 serving as switching elements are provided. This array substrate 11 is provided with pixel electrodes, not shown, which are reflecting electrodes electrically connected to drain electrodes of the thin-film transistors 18 and constitute the respective pixels 14. Further, on this array substrate 11, an alignment film, not shown, for aligning the liquid crystal layer 13 is formed to cover the pixel electrodes.

In the counter substrate 12, as shown in FIG. 1, on the principal surface on the lower side of the drawing of a transparent substrate 25 having insulation such as a glass substrate, a color filter layer, not shown, for coloring the respective pixels with, for example, the colors RGB, is provided, and common electrodes as transparent electrodes, that is, counter electrodes, not shown, are provided to cover the entire color filter layer, and an alignment film, not shown, for aligning the liquid crystal layer 13 is formed to cover the counter electrodes. On the upper side in FIG. 1, that is, on the principal surface opposing the window member 2 of the transparent substrate 25 of the counter substrate 12, a polarizing plate or the like, not shown, is provided, and on this polarizing plate, an antireflective film 30 is provided. On the display surface 31 of the liquid crystal display panel 3 as the principal surface on the window member 2 side of the antireflective film 30, an antireflective structure 33 including a plurality of convexities 32 arranged is formed.

The respective convexities 32 and the antireflective structure 33 are formed in the same shapes as the convexities 6 and the antireflective structure 7 of the window member 2.

In other words, the convexities 32 are formed into predetermined dimensions whose height and width are for example, 100 to 400 nanometers, not more than the wavelength of visible light, different from the conventional anti-glare treatment which scatters (diffuses and reflects) light by using a matted (frosted) surface formed by concaves and convexes not less than the wavelength of visible light. These convexities 32 are arranged irregularly on the entire back surface of the antireflective film 30, and the antireflective structure 33 forms a so-called moth-eye structure.

The convexities 32 are arranged so as not to have periodicity of L/K (K: integer not less than 1) when the wavelength of the visible light is defined as L. In other words, the convexities 32 are arranged in a single or a plurality of aggregations so as not to have periodicity on the wavelength level of visible light. That is, the antireflective structure 33 is constituted so as not to have wavelength dependency with respect to the visible light and view angle dependency.

As a result, by changing a rapid and discontinuous refractive index change between the air 4 and the antireflective film 30 into a continuous and gradual refractive index change by the convexities 32, the antireflective structure 33 can prevent reflection of light (external light) caused by the discontinuous and rapid refractive index change on a material interface.

The liquid crystal layer 13 is formed by filling a predetermined liquid crystal composition between the alignment film of the array substrate 11 and the alignment film of the counter substrate 12, and its periphery is sealed by a sealing layer that is not shown and held between the substrates 11 and 12.

Next, effects of the embodiment described above will be described.

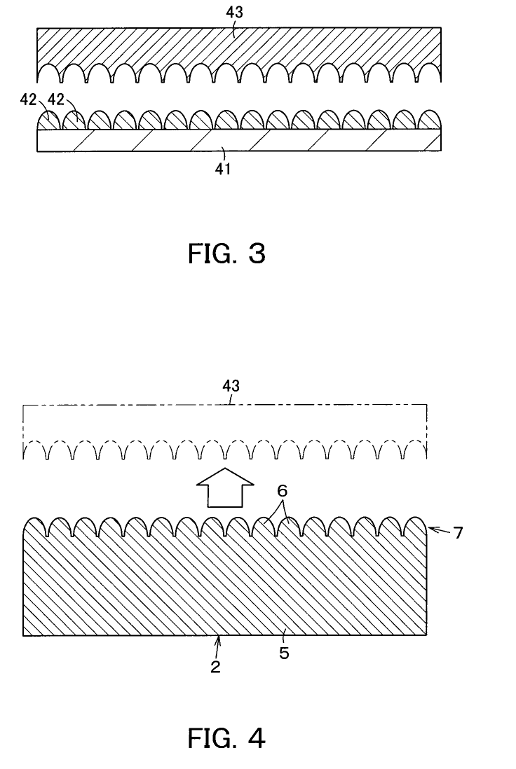

To produce the liquid crystal display element 1, for example, as shown in FIG. 3, a pattern 42 with a predetermined width and height is formed on a silicon substrate 41 by using an X-ray exposure apparatus not shown (base material forming step).

Then, as shown in FIG. 4, by using this silicon substrate 41 as a base material, a mold 43 made of nickel or the like is formed (mold forming step).

Further, by using this mold 43, the antireflective structure 7 is formed on the back surface of the window member 2 (first antireflective structure forming step).

Simultaneously, the antireflective structure 33 is formed on the antireflective film 30 (second antireflective structure forming step).

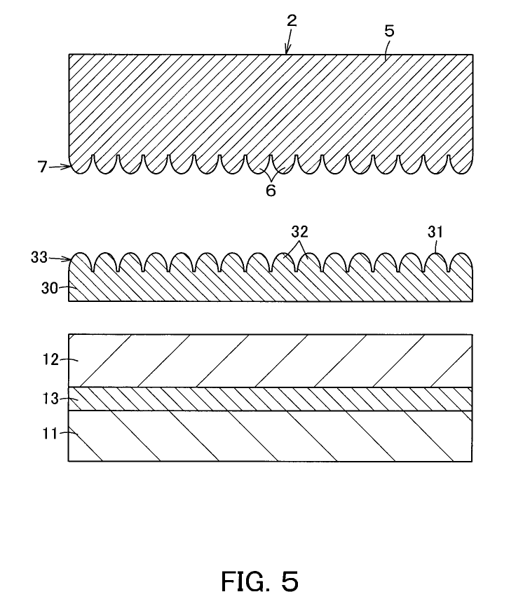

Then, on the top surface of the liquid crystal display panel 3 opposing the back surface of the window member 2, as shown in FIG. 5, the antireflective film 30 on which the antireflective structure 33 is formed is adhered (film adhering step).

If the material cost and production process allow, the antireflective structure 33 may be directly transferred onto, for example, triacetylcellulose (TAC) serving as a polarizing plate base film on the top surface of the liquid crystal display panel 3.

Thereafter, the liquid crystal display element 1 is constituted by using these window member 2 and liquid crystal display panel 3.

Then, in response to signals inputted via the scanning lines 16 from a predetermined device that is not shown, the thin film transistors 18 orthogonal to the scanning direction are turned on, and by these turned-on thin film transistors 18, image signals inputted via the signal lines 17 are written on the pixel electrodes.

In this state, as shown in FIG. 1, a part of external light I as visible light entering from above the liquid crystal display element 1 is reflected as reflected light R0 by the surface of the window member 2, and the residual of the external light I penetrates through the window member 2 and is then reflected by pixel electrodes of the liquid crystal display panel 3 and becomes outgoing light R, and when this outgoing light R penetrates through the window member 2, an image is becomes visible to a viewer.

At this time, according to the embodiment described above, by forming the same antireflective structures 7 and 33 having a plurality of convexities 6 and 32 with predetermined dimensions not more than the wavelength of visible light on the back surface of the window member 2 and the display surface 31 of the liquid crystal display panel 3, reflection of the external light I on the back surface of the window member 2 and the display surface 31 of the liquid crystal display panel 3 and reflection of the outgoing light R from the liquid crystal display panel 3 are reduced by the convexities 6 and 32 of the respective antireflective structures 7 and 33 while the liquid crystal display panel 3 is protected by the window member 2, so that the visibility is secured.

As a result, in the case of the transmission type liquid crystal display panel 3, the liquid crystal display panel 3 with transmissivity improved by reducing reflection of transmitted light according to reflection on an interface between the back surface of the window member 2 and the top surface of the liquid crystal display panel 3 disposed below the window member 2 can be stably provided at low cost, and in the case of the reflection type liquid crystal display panel 3, satisfactory contrast can be obtained.

The convexities 6 are formed on the back surface side of the window member 2, that is, the convexities 6 are not formed on the surface side of the window member 2, so that in comparison with the case where the convexities are formed on the surface side of the window member, resistance is secured against contamination and wear, and wear during use or deterioration in the concavoconvex shape and deterioration in the antireflection effect due to oily buildup between the convexities 6 due to a user's contact are prevented, so that the effect can be permanently obtained.

Further, even in the conventional case where AR (Anti-Reflection) treatment using thin-film interference is applied, it is expected to prevent reflection on the top surface of the liquid crystal display panel placed below the window member as in the case of the embodiment described above, however, coloring (violet reflection) unique to the AR treatment is visible and deteriorates the display quality, and on the other hand, by using the antireflective structures 7 and 33 which do not have wavelength dependency and view angle dependency, the coloring in question in the AR treatment can be avoided, so that improvement in visibility more than the simple addition effect of two superimposed antireflective structures 7 and 33 can be expected.

Further, by arranging the convexities 6 and 32 so as not to have periodicity of L/K (K: integer not less than 1) when the wavelength of visible light is defined as L, the reflection of the external light I by the convexities 6 and 32 of the antireflective structures 7 and 33 or aggregations of the convexities 6 and 32 can be reliably prevented.

In addition, by arranging the convexities 6 and 32 irregularly, coloring due to diffraction of visible light can be prevented.

By preferably duplicating the convexities 6 and 32 by embossing (nanoimprinting) by using a mold 43 prepared according to an electron beam drawing method or laser drawing method, etc., mass production of the window member 2 becomes easy, and further preferably, by duplication using an injection molding method by using the mold 43 obtained as described above as an injection mold, mass production becomes easier.

In the embodiment described above, the window member 2 may be structured so as to commonly serve as a touch panel. The details of the liquid crystal display panel 3 are not limited to the above-described constitution. Further, as the display element main body, other arbitrary display elements such as an organic EL can also be made compatible and used.

Next, the displays of Example 1 and Comparative example 1 of the liquid crystal display element 1 were evaluated.

Example 1 had the structure shown in the above-described embodiment in which a conical pattern 42 with a width of 300 nanometers and a height of 400 nanometers was formed on the silicon substrate 41 by using an X-ray exposure apparatus, and by using a mold 43 formed by using this silicon substrate 41 as a base material, an antireflective structure 7 was formed on the back surface of the window member 2. An antireflective film 30 made of polymethylmethacrylate (PMMA) having an antireflective structure 33 formed by using the mold 43 was adhered on the polarizing plate of the liquid crystal display panel 3.

On the other hand, according to Comparative example 1, instead of the antireflective film 30 having an antireflective structure 33 of Example 1, an AR film was provided on the top surface of the liquid crystal display panel 3.

In the liquid crystal display elements thus prepared, their displays were compared with each other, and it was confirmed that in the liquid crystal display element of Conventional example 1, the display was colored with violet due to reflection on the AR film on the top surface of the liquid crystal display panel 3 disposed below the window member 2, and on the other hand, in the liquid crystal display element 1 of Example 1, the display was not colored and satisfactory display was possible.

What is claimed is:

1. A display element comprising:
a display element main body including a display surface on which images are displayed; and
a window member which is translucent and provided so as to oppose the display surface of the display element main body, wherein
on the display surface and a principal surface of the window member opposing the display surface, the same antireflective structure having a plurality of convexities with predetermined dimensions not more than the wavelength of visible light is formed, respectively.

2. The display element according to claim 1, wherein
each of the convexities is formed so as to have a height and a width of 100 to 400 nanometers, and so as not to have periodicity of L/K (K: integer not less than 1) when the wavelength of visible light is defined as L.

3. The display element according to claim 1, wherein
the concavities and convexities of each antireflective structure are formed by embossing.

4. The display element according to claim 1, wherein
between the window member and the display surface of the display element main body, a medium with a refractive index of 1 is provided.

5. The display element according to claim 1, wherein
the antireflective structure of the display element main body side is formed on an antireflective film constituting the display surface.

6. The display element according to claim 1, wherein
the display element main body includes an array substrate, a counter substrate which opposes the array substrate and has the display surface, and a liquid crystal layer interposed between the array substrate and the counter substrate.
